(19) United States
(12) Patent Application Publication
(10) Pub. No.: US 2026/0128563 A1
(43) Pub. Date: May 7, 2026

(54) FPGA-BASED CONTROL SYSTEM AND METHOD FOR TI:SAPPHIRE LASER

(71) Applicant: Shanxi University, Taiyuan City (CN)

(72) Inventors: Pixian JIN, Taiyuan City (CN); Tianyang WANG, Taiyuan City (CN); Jing SU, Taiyuan City (CN); Huadong LU, Taiyuan City (CN)

(21) Appl. No.: 19/378,039

(22) Filed: Nov. 3, 2025

(30) Foreign Application Priority Data
Nov. 4, 2024 (CN) 202411559552.6

(51) Int. Cl. H01S 3/139; H01S 3/081; H01S 3/13; H01S 3/16

(52) U.S. Cl. CPC H01S 3/139; H01S 3/0816; H01S 3/1305; H01S 3/1625; H01S 3/1636

(57) ABSTRACT

Disclosed are a Field-Programmable Gate Array (FPGA)-based control system and method for a titanium:sapphire (Ti:sapphire) laser. The system includes a laser control module, a pump source, a first plano-concave mirror, a second plano-concave mirror, a first plane mirror, a second plane mirror, a Ti:sapphire crystal, a birefringent filter, a piezoelectric rotation motor, piezoelectric ceramic, a piezoelectric control board, an etalon, a galvanometer motor, a first beam splitter, a photodetector, a second beam splitter, and a high-precision wavelength meter. This application integrates control over the birefringent filter, the etalon, and the piezoelectric ceramics. By utilizing the laser control module, automatic tuning of output wavelengths of Ti:sapphire lasers is achieved. Once a target wavelength value is provided, the birefringent filter, the etalon, and the piezoelectric ceramics are automatically and sequentially controlled, realizing the tuning of output wavelengths of all-solid-state continuous-wave single-frequency Ti:sapphire lasers, and accurately controlling the output wavelengths of the lasers.

### CROSS REFERENCE TO RELATED APPLICATION

This patent application claims the benefit and priority of Chinese Patent Application No. 202411559552.6, filed with the China National Intellectual Property Administration on November 04, 2024, the disclosure of which is incorporated by reference herein in its entirety as part of the present application.

### TECHNICAL FIELD

The present disclosure relates to the field of titanium:sapphire (Ti:sapphire) laser control, and in particular, to a Field-Programmable Gate Array (FPGA)-based control system and method for a Ti:sapphire laser.

### BACKGROUND

As one of the most promising new-generation laser sources, the all-solid-state continuous-wave single-frequency Ti:sapphire laser combines the advantages of conventional solid-state lasers and semiconductor lasers. It offers numerous benefits, including compact size, continuous frequency tunability, lightweight design, broad output spectrum, high power output, stable performance, excellent reliability, long operational lifespan, and high beam quality. It stands as one of the most significant broadband tunable laser sources available today, with extensive applications in many critical fields such as quantum optics, atomic physics, spectroscopy, biomedicine, quantum communication, gravitational wave detection, and lidar.

With ongoing research on Ti:sapphire lasers across Chinese universities and institutions, the all-solid-state continuous-wave single-frequency Ti:sapphire laser is evolving toward ultra-high power, ultra-fast performance, ultra-short pulses, and ultra-stable operation, achieving further practical deployment. A series of locking and control mechanisms for the various components of the Ti:sapphire laser constitutes a critical part of this process. Currently, various methods are employed to control the Ti:sapphire laser, yet the vast majority of systems rely on manual devices which suffer from limited flexibility, complex internal structures, and cumbersome wiring. If control failures occur, operators must conduct systematic troubleshooting and manual repairs, demanding a high level of expertise. Moreover, all required signal channels for the system must be sourced from external signal generators, while waveform observation requires connection to an oscilloscope. This results in cumbersome and complex operation of the Ti:sapphire laser, thereby increasing the rate of human error and ultimately impeding research progress. Furthermore, the control of intracavity components, such as the birefringent filter, the etalon, and the piezoelectric ceramic, remains sparse, lacking a highly integrated and automated control system. Thus, further innovation in the control and locking systems of the Ti:sapphire laser has become particularly crucial.

### SUMMARY

An objective of the present disclosure is to provide an FPGA-based control system and method for a Ti:sapphire laser, to improve the control speed and precision of Ti:sapphire lasers.

To achieve the above objective, the present disclosure provides the following solutions:

In the first aspect, the present disclosure provides an FPGA-based control system for a Ti:sapphire laser, including: a laser control module, a pump source, a first plano-concave mirror, a second plano-concave mirror, a first plane mirror, a second plane mirror, a Ti:sapphire crystal, a birefringent filter, a piezoelectric rotation motor, piezoelectric ceramic, a piezoelectric control board, an etalon, a galvanometer motor, a first beam splitter, a photodetector, a second beam splitter, and a high-precision wavelength meter, where

the pump source is configured to emit laser light; the first plano-concave mirror is located on an outgoing path of the laser light; the Ti:sapphire crystal and the second plano-concave mirror are sequentially arranged on an outgoing path of the first plano-concave mirror; the Ti:sapphire crystal is arranged between the first plano-concave mirror and the second plano-concave mirror at a Brewster's angle; the piezoelectric rotation motor and the first plane mirror are sequentially arranged on a reflection path of the second plano-concave mirror; the birefringent filter is disposed inside the piezoelectric rotation motor; the piezoelectric control board is connected to the piezoelectric rotation motor; the piezoelectric ceramic is bonded to the first plane mirror; the galvanometer motor and the second plane mirror are sequentially arranged on a reflection path of the first plane mirror; the etalon is disposed inside the galvanometer motor; the first plano-concave mirror is also located on a reflection path of the second plane mirror; the first beam splitter and the second beam splitter are sequentially arranged on an outgoing path of the second plane mirror; the photodetector is disposed on a reflection path of the first beam splitter; the high-precision wavelength meter is disposed on a reflection path of the second beam splitter;

the piezoelectric ceramic, the piezoelectric control board, the galvanometer motor, the photodetector, and the high-precision wavelength meter are all connected to the laser control module;

the high-precision wavelength meter is configured to read a current wavelength value of laser light emitted by a Ti:sapphire laser; the pump source, the first plano-concave mirror, the second plano-concave mirror, the first plane mirror, the second plane mirror, the Ti:sapphire crystal, the birefringent filter, the piezoelectric rotation motor, the piezoelectric ceramic, the etalon, and the galvanometer motor constitute the Ti:sapphire laser; and

the laser control module sequentially controls the piezoelectric control board, the galvanometer motor, and the piezoelectric ceramic according to the current wavelength value and a target wavelength value to adjust a wavelength of the laser light emitted by the Ti:sapphire laser.

Optionally, the laser control module includes a computer, an FPGA control board, an analog-to-digital converter (ADC), a digital-to-analog converter (DAC), a high-voltage amplifier, and a Thunderbolt to Peripheral Component Interconnect Express (PCIe) expansion chassis;

the FPGA control board is connected to the computer through the Thunderbolt to PCIe expansion chassis; the ADC and the DAC are installed on the FPGA control board; the ADC is connected to the photodetector; the DAC is separately connected to the galvanometer motor and the high-voltage amplifier; and the computer is connected to the high-precision wavelength meter; and

the computer is configured to sequentially control the piezoelectric control board, the galvanometer motor, and the piezoelectric ceramic according to the current wavelength value and the target wavelength value.

Optionally, the piezoelectric ceramic includes first piezoelectric ceramic and second piezoelectric ceramic; the first piezoelectric ceramic, the second piezoelectric ceramic, and the first plane mirror are bonded in sequence; the first piezoelectric ceramic has a displacement greater than 20 μm; and the second piezoelectric ceramic has a displacement less than 10 μm.

Optionally, the high-precision wavelength meter is a WS7-series wavelength meter.

Optionally, the photodetector performs signal detection by means of extracavity detection.

Optionally, the high-voltage amplifier is a broadband high-voltage amplifier having a high slew rate greater than 3 V/μs.

In the second aspect, the present disclosure provides an FPGA-based control method for a Ti:sapphire laser, where the FPGA-based control method for a Ti:sapphire laser is applied to the FPGA-based control system for a Ti:sapphire laser, and includes:

acquiring the current wavelength value;

controlling the piezoelectric rotation motor to rotate until an absolute value of a difference between the current wavelength value and the target wavelength value is less than or equal to a first preset value, and stopping rotating the piezoelectric rotation motor;

controlling the galvanometer motor to rotate to change an angle of the etalon until the difference between the current wavelength value and the target wavelength value is greater than 0 and less than or equal to a second preset value, and controlling to lock the etalon, the second preset value being less than the first preset value; and

controlling the first piezoelectric ceramic to extend and retract until the difference between the current wavelength value and the target wavelength value is less than or equal to a third preset value, and controlling the second piezoelectric ceramic to stabilize a wavelength of laser light, the third preset value being less than the second preset value.

Optionally, the first preset value is 0.4 nm; the second preset value is 0.03 nm; and the third preset value is 0.1 pm.

According to specific embodiments provided in the present disclosure, the present disclosure has the following technical effects:

The present disclosure provides an FPGA-based control system and method for a Ti:sapphire laser. The system includes a laser control module, a pump source, a first plano-concave mirror, a second plano-concave mirror, a first plane mirror, a second plane mirror, a Ti:sapphire crystal, a birefringent filter, a piezoelectric rotation motor, piezoelectric ceramic, a piezoelectric control board, an etalon, a galvanometer motor, a first beam splitter, a photodetector, a second beam splitter, and a high-precision wavelength meter. The present disclosure integrates control over the birefringent filter, the etalon, and the piezoelectric ceramics. By utilizing the laser control module, automatic tuning of output wavelengths of Ti:sapphire lasers is achieved. Once a target wavelength value is provided, the birefringent filter, the etalon, and the piezoelectric ceramics are automatically and sequentially controlled, realizing the automatical tuning of output wavelengths of all-solid-state continuous-wave single-frequency Ti:sapphire lasers, and accurately controlling the output wavelengths of the lasers.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a flowchart of an FPGA-based control system for a Ti:sapphire laser according to one embodiment of the present disclosure;

FIG. 2 is a schematic diagram of interaction between an internal structure of a laser control module and a laser according to the present disclosure; and

FIG. 3 is a schematic diagram of a control interface of a single-frequency continuous-wave all-solid-state Ti:sapphire laser realizing automatic broad tuning according to the present disclosure.

Reference Numerals: 1. Pump source; 2. First plano-concave mirror; 3. Ti:sapphire crystal; 4. Second plano-concave mirror; 5. Birefringent filter; 6. Piezoelectric rotation motor; 7-1. First piezoelectric ceramic; 7-2. Second piezoelectric ceramic; 8. First plane mirror; 9. Piezoelectric control board; 10. Etalon; 11. Galvanometer motor; 12. Laser control module; 12-1. Computer; 12-2. FPGA control board; 12-3. ADC; 12-4. DAC; 12-5. High-voltage amplifier; 12-6. Thunderbolt to PCIe expansion chassis; 13. Second plane mirror; 14. First beam splitter; 15. Photodetector; 16. Second beam splitter; and 17. High-precision wavelength meter.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

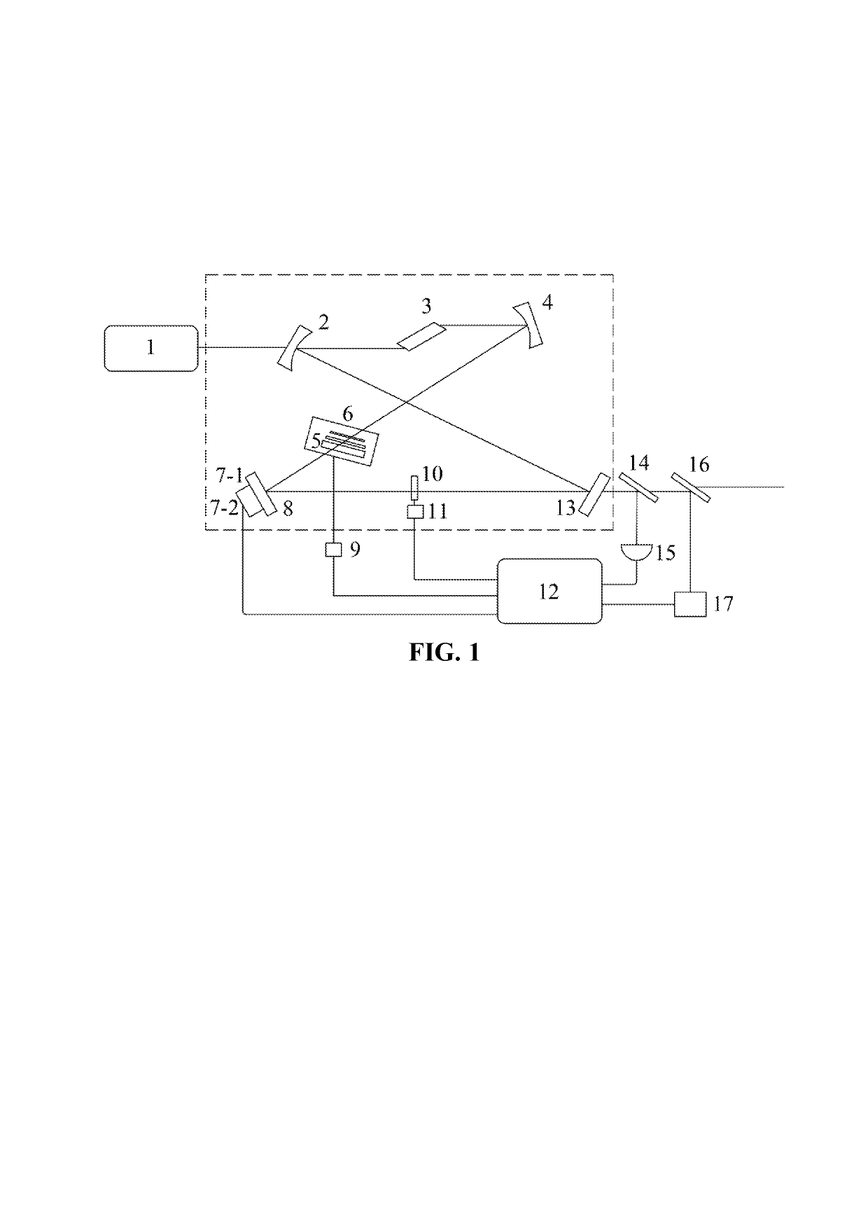

In one exemplary embodiment, as shown in FIG. 1, provided is an FPGA-based control system for a Ti:sapphire laser, including: a laser control module 12, a pump source 1, a first plano-concave mirror 2, a second plano-concave mirror 4, a first plane mirror 8, a second plane mirror 13, a Ti:sapphire crystal 3, a birefringent filter 5, a piezoelectric rotation motor 6, piezoelectric ceramic, a piezoelectric control board 9, an etalon 10, a galvanometer motor 11, a first beam splitter 14, a photodetector 15, a second beam splitter 16, and a high-precision wavelength meter 17.

The pump source 1 is configured to emit laser light; the first plano-concave mirror 2 is located on an outgoing path of the laser light; the Ti:sapphire crystal 3 and the second plano-concave mirror 4 are sequentially arranged on an outgoing path of the first plano-concave mirror 2; the Ti:sapphire crystal 3 is arranged between the first plano-concave mirror 2 and the second plano-concave mirror 4 at a Brewster's angle; the piezoelectric rotation motor 6 and the first plane mirror 8 are sequentially arranged on a reflection path of the second plano-concave mirror 4; the birefringent filter 5 is disposed inside the piezoelectric rotation motor 6; the piezoelectric control board 9 is connected to the piezoelectric rotation motor 6; the piezoelectric ceramic is bonded to the first plane mirror 8; the galvanometer motor 11 and the second plane mirror 13 are sequentially arranged on a reflection path of the first plane mirror 8; the etalon 10 is disposed inside the galvanometer motor 11; the first plano-concave mirror 2 is also located on a reflection path of the second plane mirror 13; the first beam splitter 14 and the second beam splitter 16 are sequentially arranged on an outgoing path of the second plane mirror 13; the photodetector 15 is disposed on a reflection path of the first beam splitter 14; the high-precision wavelength meter 17 is disposed on a reflection path of the second beam splitter 16; and the high-precision wavelength meter 17 is connected to the laser control module 12 via an Universal Serial Bus (USB) interface.

In practical applications, the first plano-concave mirror 2, the second plano-concave mirror 4, the first plane mirror 8, and the second plane mirror 13 constitute a four-mirror ring laser resonator.

The piezoelectric ceramic, the piezoelectric control board 9, the galvanometer motor 11, the photodetector 15, and the high-precision wavelength meter 17 are all connected to the laser control module 12. The piezoelectric ceramic includes first piezoelectric ceramic (long-range piezoelectric ceramic) 7-1 and second piezoelectric ceramic (short-range piezoelectric ceramic) 7-2. The first piezoelectric ceramic 7-1 is bonded to the second piezoelectric ceramic; and the second piezoelectric ceramic 7-2 is bonded to the first plane mirror 8. The first piezoelectric ceramic 7-1 has a displacement greater than 20 μm; and the second piezoelectric ceramic 7-2 has a displacement less than 10 μm.

In practical applications, the piezoelectric control board 9 is connected to the laser control module 12 by means of serial port communication; the galvanometer motor 11 is connected to the laser control module 12 through a Bayonet Neill-Concelman (BNC) wire; and the first piezoelectric ceramic 7-1 and the second piezoelectric ceramic 7-2 are connected to the laser control module 12 through BNC wires.

The high-precision wavelength meter 17 is configured to read a current wavelength value of laser light emitted by the Ti:sapphire laser.

The laser control module 12 sequentially controls the piezoelectric control board 9, the galvanometer motor 11, and the piezoelectric ceramic according to the current wavelength value and a target wavelength value to adjust a wavelength of the laser light emitted by the Ti:sapphire laser.

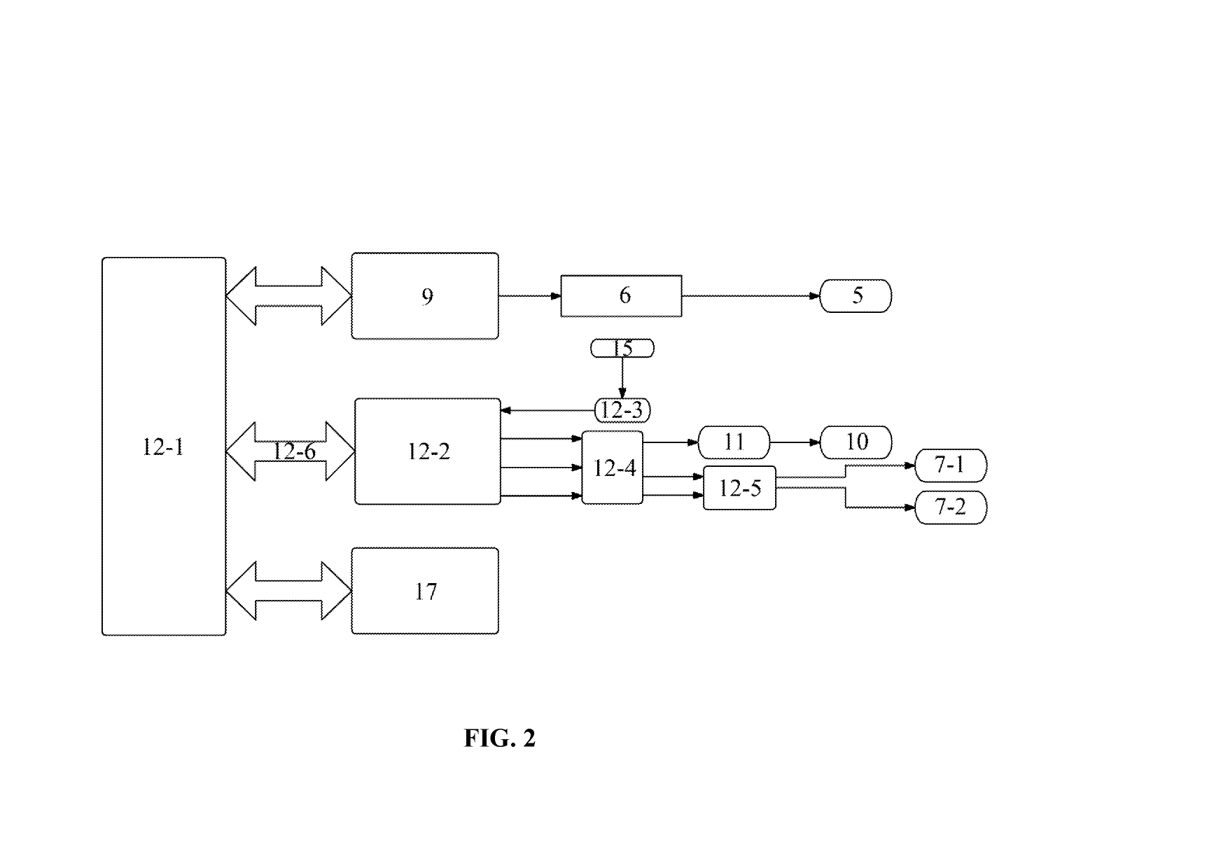

As shown in FIG. 2, the laser control module 12 includes a computer 12-1, an FPGA control board 12-2, an ADC 12-3, a DAC 12-4, a high-voltage amplifier 12-5, and a Thunderbolt to PCIe expansion chassis 12-6.

The FPGA control board 12-2 is connected to the computer 12-1 through the Thunderbolt to PCIe expansion chassis 12-6; the ADC 12-3 and the DAC 12-4 are installed on the FPGA control board 12-2; the ADC 12-3 is connected to the photodetector 15; the DAC 12-4 is separately connected to the galvanometer motor 11 and the high-voltage amplifier 12-5; and the computer 12-1 is connected to the high-precision wavelength meter 17. A control program built in the computer 12-1 collects in real time the current wavelength value of the laser light measured by the high-precision wavelength meter 17, and then sequentially controls the piezoelectric rotation motor 6, the galvanometer motor 11, the long-range piezoelectric ceramic, and the short-range piezoelectric ceramic to realize large-range continuous tuning of the output wavelength.

The computer 12-1 is configured to sequentially control the piezoelectric control board 9, the galvanometer motor 11, and the piezoelectric ceramic according to the current wavelength value and the target wavelength value.

In this embodiment, the FPGA control board 12-2 is an FPGA having a PCIe function in the Xilinx company. The high-precision wavelength meter 17 is a WS7-series wavelength meter in the Highfinesse company. The piezoelectric control board 9 is a control board matched with the piezoelectric rotation motor 6 AG-PR100 provided by the NewPort company. The ADC 12-3 is a 12-bit resolution AD9238 chip. The DAC 12-4 is a 14-bit resolution AD9767 chip. The photodetector 15 performs signal detection by means of extracavity detection. The high-voltage amplifier 12-5 is a broadband high-voltage amplifier having a high slew rate. The high slew rate is greater than 3 V/μs.

A LabVIEW-based computer control program must operate on a computer equipped with a Thunderbolt interface.

In one exemplary embodiment, the present disclosure provides an FPGA-based control method for a Ti:sapphire laser. The FPGA-based control method for a Ti:sapphire laser is applied to the FPGA-based control system for a Ti:sapphire laser, and includes:

acquire the current wavelength value;

control the piezoelectric rotation motor 6 to rotate until an absolute value of a difference between the current wavelength value and the target wavelength value is less than or equal to a first preset value, and stop rotating the piezoelectric rotation motor 6;

control the galvanometer motor 11 to rotate to change an angle of the etalon 10 until the difference between the current wavelength value and the target wavelength value is greater than 0 and less than or equal to a second preset value, and control to lock the etalon 10, the second preset value being less than the first preset value; and

control the first piezoelectric ceramic to extend and retract until the difference between the current wavelength value and the target wavelength value is less than or equal to a third preset value, and control the second piezoelectric ceramic to stabilize a wavelength of laser light, the third preset value being less than the second preset value.

As one optional implementation, the first preset value is 0.4 nm; the second preset value is 0.03 nm; and the third preset value is 0.1 pm.

The FPGA-based control system for a Ti:sapphire laser performs automatic accurate control and locking on the output wavelength of the laser.

The birefringent filter 5 is installed in the piezoelectric rotation motor 6 (AG-PR100) provided by the NewPort company. In the present disclosure, a function of the motor provided by the NewPort company is called and integrated in a LabVIEW program, establishing two operational modes: a stepping mode (configurable in steps) and a continuous rotation mode, with multiple speed levels available to accommodate different application requirements. The control of the etalon 10, the long-range piezoelectric ceramic, and the short-range piezoelectric ceramic in the present disclosure can be divided into a locking system and a tuning system. The etalon 10 is installed in the galvanometer motor 11, and the long-range piezoelectric ceramic and the short-range piezoelectric ceramic are bonded to a cavity mirror. In the locking system, the ADC 12-3 first collects a 1 kHz electrical signal detected by the photodetector 15. As the collected detection signal contains signals of other frequencies, which impedes accurate signal observation, a Xilinx Internet Protocol (IP) core is called to generate a bandpass filter centered at 1 kHz, thereby extracting a 1 kHz signal from the detection signal. A Direct Digital Synthesis (DDS) signal generator inside the FPGA control board 12-2 generates two 1 kHz sinusoidal signals having identical frequency and adjustable relative phases. One signal serves as a modulation signal, which is applied to a control board of the galvanometer motor to act upon the etalon 10. The other signal functions as a demodulation signal, which is mixed with the filtered detection signal and passes through a 2 kHz low-pass filter. After filtering out a high-frequency component generated by mixing, the extracted signal represents a deviation signal between the transmission peak of the etalon and an oscillation mode of the laser resonator, i.e., an error signal. This error signal is then processed by a proportional amplification and integration module to generate a control signal. An input control is configured as a direct-current signal, which is output by the DAC 12-4, and an input range of the control is set from -8191 to +8191 to distinguish symbols of output voltages, corresponding to voltages of ±5 V. The generated control signal, a direct-current bias signal, and the modulation signal are combined via an adder and subsequently applied to the control board of the galvanometer motor 11. The computer 12-1 issues an instruction to lock the etalon 10, enabling feedback control of an incident angle of the etalon 10. Furthermore, a waveform chart is configured on a control interface of the computer. The PCIe interface of the FPGA control board 12-2 is inserted into the Thunderbolt to PCIe expansion chassis 12-6, transmitting data to the computer 12-1, thereby displaying, on the computer 12-1, the modulation signal, the demodulation signal, the error signal, and the signal applied to the etalon 10. In the tuning system, the FPGA control board 12-2 generates a triangular wave signal having an adjustable frequency and amplitude, and this signal is input into the custom-built high-voltage amplifier 12-5 by the DAC 12-4. The control program then regulates the direct-current bias voltage of the high-voltage amplifier 12-5 and the gain of the input signal, such that the high-voltage amplifier 12-5 generates a high-voltage linear scanning signal, and this signal is applied to the long-range piezoelectric ceramic bonded with the cavity mirror, linearly scanning the length of the laser light resonator cavity to achieve continuous tuning of the laser. Additionally, frequency stabilization of the laser light is realized through the PID control of the short-range piezoelectric ceramic.

The principle of the function of automatically and precisely controlling the output wavelength is as follows: the Ti:sapphire laser is controlled to output the laser light, the first beam splitter 14 and the second beam splitter 16 divide the laser light into two beams, and the remaining laser light serves as main laser light output. One beam enters the photodetector 15, and the other beam enters the high-precision wavelength meter 17 for wavelength monitoring. The target wavelength value λ_{M} is set, and the current wavelength value λ_{S} can be read in real time by the high-precision wavelength meter 17. The piezoelectric rotation motor 6 is rotated to adjust the angle of the birefringent filter 5. According to the intracavity structure and the characteristics of the laser, each rotation of the piezoelectric rotation motor 6 changes the output wavelength by 0.4 nm. The rotation of the piezoelectric rotation motor 6 is stopped when |λ_{M}-λ_{S}|<=0.4 nm. Then, by adjusting the direct-current bias signal in the locking system, the galvanometer motor 11 is controlled to change the angle of the etalon 10. When the condition 0<λ_{M}-λ_{S}≤0.03 nm is met, the adjustment of the direct-current bias signal is stopped and the PI switch is activated to lock the etalon 10. After the etalon 10 is locked, the program adjusts the direct-current voltage in the tuning system, which is applied to the long-range piezoelectric ceramic by the high-voltage amplifier 12-5. The expansion or contraction of the long-range piezoelectric ceramic is controlled to adjust the output wavelength. The adjustment of the direct-current voltage is stopped when the condition λ_{M}-λ_{S}≤0.1 pm is met. In this case, the program automatically activates the PID module controlling the short-range piezoelectric ceramic to dynamically stabilize the laser light frequency, thereby maintaining the difference between the output wavelength of the laser and the set target wavelength within the range of 0.1 pm.

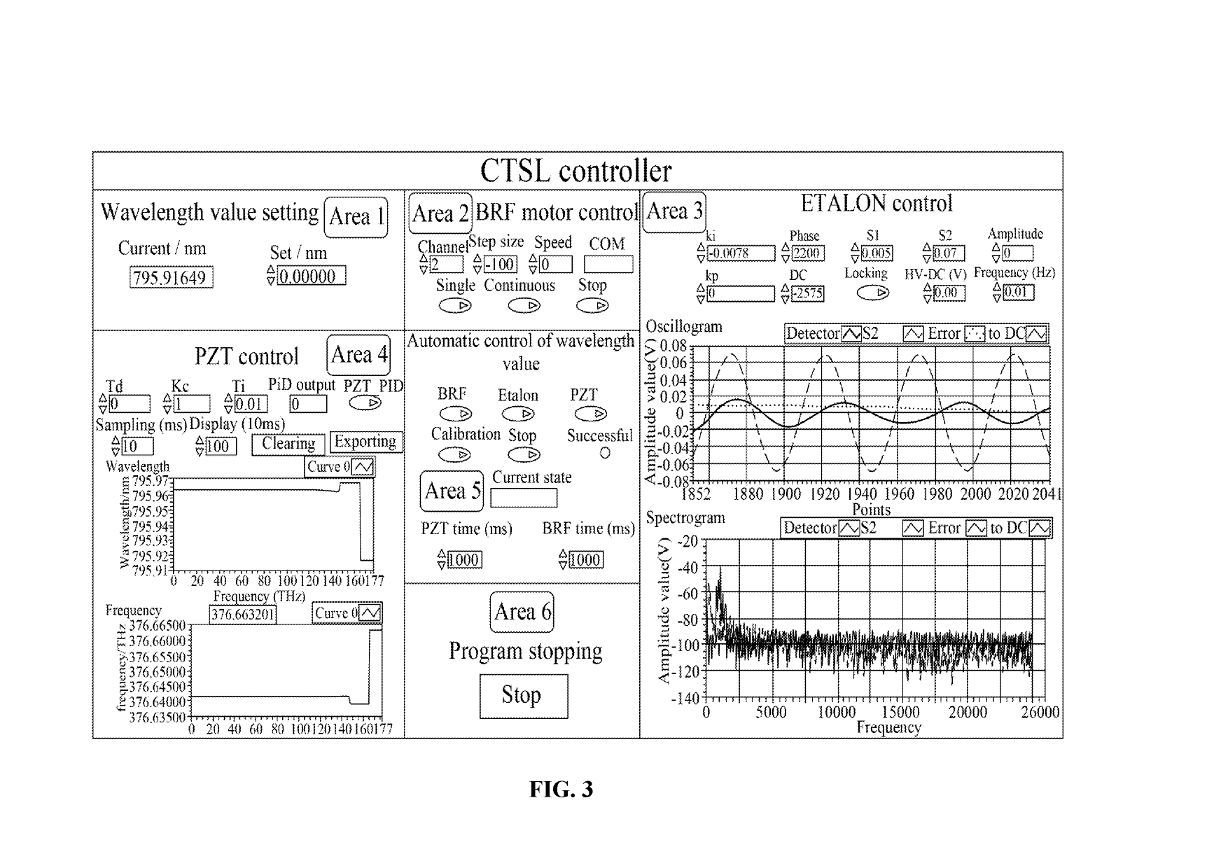

FIG. 3 shows a control interface of a single-frequency continuous-wave all-solid-state Ti:sapphire laser realizing automatic broad tuning in this embodiment. In FIG. 3, area 1 is a wavelength value setting section, including the functions of setting and reading the wavelength. Area 2 is a control section for the birefringent filter 5, allowing single-stepping or continuous stepping of a user-defined step size by the piezoelectric rotation motor 6. Area 3 is a control section for the etalon 10, including a locking module, an amplitude-adjustable modulation/demodulation signal, a direct-current bias signal, a triangular wave signal having an adjustable frequency and amplitude, and a virtual oscilloscope. Area 4 is a control section for the long-range piezoelectric ceramic and the short-range piezoelectric ceramic, including a PID frequency stabilization module and a virtual oscilloscope. Area 5 is an automatic wavelength value control section. Upon clicking an automatic calibration button, the program sequentially adjusts the piezoelectric rotation motor 6 equipped with the birefringent filter 5, the galvanometer motor 11, the long-range piezoelectric ceramic, and the short-range piezoelectric ceramic. The automatic calibration is stopped when the difference between the current wavelength value and the target wavelength value is less than or equal to 0.1 pm. Additionally, individual automatic calibration of the components, i.e., the piezoelectric rotation motor 6 equipped with the birefringent filter 5, the galvanometer motor 11, the long-range piezoelectric ceramic, and the short-range piezoelectric ceramic, can be performed through separate control operations. Area 6 is a program stopping section.

In the present disclosure, the FPGA control board 12-2 is used to replace the single-chip microcomputer and various circuit boards in the original system. The analog circuit-based control system is converted into a digital circuit-based program, which is then compiled using VIVADO and burned into the FPGA control board 12-2. The PCIe interface on the FPGA control board 12-2 enables interaction between a host computer and a slave controller. The program utilizes the DDS signal generator to produce the modulation and demodulation signals required for control purposes. The virtual oscilloscope is implemented to directly display the collected and issued data on the computer 12-1, thereby replacing the external signal generator and oscilloscope required by the original system. A digital bandpass filter having a center frequency of 1 kHz is provided to extract the required 1 kHz signal from the photodetector signal, facilitating subsequent observation and the locking of the intracavity etalon 10. By monitoring the signal waveform and data transmitted from the FPGA to the host computer, the input and output signals are adjusted, achieving easy operation and commercial application.

The control of the birefringent filter 5, the etalon 10, and the piezoelectric ceramic is integrated, enabling automatic and precise control of the output wavelength of the laser. Furthermore, the laser control module 12 can read the wavelength value collected by the high-precision wavelength meter 17 and display same in real time in the control program. The control program controls the piezoelectric rotation motor 6 equipped with the birefringent filter 5. By adjusting the voltage applied to the long-range piezoelectric ceramic and scanning the length of the piezoelectric ceramic, the length of the laser resonator can be continuously adjusted, thereby altering the output wavelength of the laser. The laser frequency stabilization function is set, the PID control algorithm is employed to output a direct-current signal to the high-voltage amplifier 12-5. The output end of the high-voltage amplifier 12-5 is connected into the laser, acting on a short-range piezoelectric ceramic inside the laser to precisely scan and lock the cavity length of the resonator. Additionally, the function of automatically controlling the output wavelength is set. By simply inputting the target wavelength value, the program will continuously calculate the difference between the real-time wavelength value λ_{M} and the system-set target wavelength value λ_{S}, and progressively control the birefringent filter 5, the etalon 10, and the piezoelectric ceramic, achieving one-click precise control of the output wavelength.

The present disclosure has the following advantages:

High Integration: in a same control system, three optical elements in the Ti:sapphire laser are controlled, and the output wavelength of the laser is automatically and precisely controlled through different determination conditions. Additionally, wavelength value reading, signal display, signal generation, and other functions are integrated in the system, replacing the external oscilloscope and signal source required by the original system.

System simplification: the new-generation control system features fewer external interfaces and internal connections, facilitating easier connection, fabrication, and testing. Locking the etalon does not require zeroing the error signal, thereby streamlining the locking step. The use of LabVIEW for developing the FPGA control board reduces code volume and accelerates the development progress.

Function upgrading: digital filtering is performed on the collected detection signal to remove a high-frequency interference signal therein, thereby facilitating the observation of the detection signal and facilitating the locking of the etalon. The setting of the automatic control function realizes one-click precise control of the output wavelength of the laser.

This disclosure facilitates the further advancement of Ti:sapphire lasers toward intelligence, automation, and convenience. While improving the practicability and commerciality of the laser, the operational and maintenance complexity is reduced, and the labor and material costs are lowered. Furthermore, the integration of FPGA hardware, computer algorithms, and laser locking control achieves interdisciplinary convergence, representing a highly innovative and promising direction. This approach significantly advances the in-depth research on all-solid-state continuous-wave single-frequency Ti:sapphire lasers.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A Field-Programmable Gate Array (FPGA)-based control system for a titanium:sapphire (Ti:sapphire) laser, comprising: a laser control module, a pump source, a first plano-concave mirror, a second plano-concave mirror, a first plane mirror, a second plane mirror, a Ti:sapphire crystal, a birefringent filter, a piezoelectric rotation motor, piezoelectric ceramic, a piezoelectric control board, an etalon, a galvanometer motor, a first beam splitter, a photodetector, a second beam splitter, and a high-precision wavelength meter, wherein
the pump source is configured to emit laser light; the first plano-concave mirror is located on an outgoing path of the laser light; the Ti:sapphire crystal and the second plano-concave mirror are sequentially arranged on an outgoing path of the first plano-concave mirror; the Ti:sapphire crystal is arranged between the first plano-concave mirror and the second plano-concave mirror at a Brewster's angle; the piezoelectric rotation motor and the first plane mirror are sequentially arranged on a reflection path of the second plano-concave mirror; the birefringent filter is disposed inside the piezoelectric rotation motor; the piezoelectric control board is connected to the piezoelectric rotation motor; the piezoelectric ceramic is bonded to the first plane mirror; the galvanometer motor and the second plane mirror are sequentially arranged on a reflection path of the first plane mirror; the etalon is disposed inside the galvanometer motor; the first plano-concave mirror is also located on a reflection path of the second plane mirror; the first beam splitter and the second beam splitter are sequentially arranged on an outgoing path of the second plane mirror; the photodetector is disposed on a reflection path of the first beam splitter; the high-precision wavelength meter is disposed on a reflection path of the second beam splitter;
the piezoelectric ceramic, the piezoelectric control board, the galvanometer motor, the photodetector, and the high-precision wavelength meter are all connected to the laser control module;
the high-precision wavelength meter is configured to read a current wavelength value of laser light emitted by the Ti:sapphire laser; the pump source, the first plano-concave mirror, the second plano-concave mirror, the first plane mirror, the second plane mirror, the Ti:sapphire crystal, the birefringent filter, the piezoelectric rotation motor, the piezoelectric ceramic, the etalon, and the galvanometer motor constitute the Ti:sapphire laser; and
the laser control module sequentially controls the piezoelectric control board, the galvanometer motor, and the piezoelectric ceramic according to the current wavelength value and a target wavelength value to adjust a wavelength of the laser light emitted by the Ti:sapphire laser.

2. The FPGA-based control system for a Ti:sapphire laser according to claim 1, wherein the laser control module comprises a computer, an FPGA control board, an analog-to-digital converter (ADC), a digital-to-analog converter (DAC), a high-voltage amplifier, and a Thunderbolt to Peripheral Component Interconnect Express (PCIe) expansion chassis;
the FPGA control board is connected to the computer through the Thunderbolt to PCIe expansion chassis; the ADC and the DAC are installed on the FPGA control board; the ADC is connected to the photodetector; the DAC is separately connected to the galvanometer motor and the high-voltage amplifier; and the computer is connected to the high-precision wavelength meter; and
the computer is configured to sequentially control the piezoelectric control board, the galvanometer motor, and the piezoelectric ceramic according to the current wavelength value and the target wavelength value.

3. The FPGA-based control system for a Ti:sapphire laser according to claim 1, wherein the piezoelectric ceramic comprises first piezoelectric ceramic and second piezoelectric ceramic; the first piezoelectric ceramic, the second piezoelectric ceramic, and the first plane mirror are bonded in sequence; the first piezoelectric ceramic has a displacement greater than 20 μm; and the second piezoelectric ceramic has a displacement less than 10 μm.

4. The FPGA-based control system for a Ti:sapphire laser according to claim 1, wherein the high-precision wavelength meter is a WS7-series wavelength meter.

5. The FPGA-based control system for a Ti:sapphire laser according to claim 1, wherein the photodetector performs signal detection by means of extracavity detection.

6. The FPGA-based control system for a Ti:sapphire laser according to claim 1, wherein the high-voltage amplifier is a broadband high-voltage amplifier having a high slew rate greater than 3 V/μs.

7. An FPGA-based control method for a Ti:sapphire laser, wherein the FPGA-based control method for a Ti:sapphire laser is applied to the FPGA-based control system for a Ti:sapphire laser according to claim 1, and comprises:
acquiring the current wavelength value;
controlling the piezoelectric rotation motor to rotate until an absolute value of a difference between the current wavelength value and the target wavelength value is less than or equal to a first preset value, and stopping rotating the piezoelectric rotation motor;
controlling the galvanometer motor to rotate to change an angle of the etalon until the difference between the current wavelength value and the target wavelength value is greater than 0 and less than or equal to a second preset value, and controlling to lock the etalon, the second preset value being less than the first preset value; and
controlling the first piezoelectric ceramic to extend and retract until the difference between the current wavelength value and the target wavelength value is less than or equal to a third preset value, and controlling the second piezoelectric ceramic to stabilize a wavelength of laser light, the third preset value being less than the second preset value.

8. The FPGA-based control method for a Ti:sapphire laser according to claim 7, wherein the first preset value is 0.4 nm; the second preset value is 0.03 nm; and the third preset value is 0.1 pm.

9. The FPGA-based control method for a Ti:sapphire laser according to claim 7, wherein the laser control module comprises a computer, an FPGA control board, an analog-to-digital converter (ADC), a digital-to-analog converter (DAC), a high-voltage amplifier, and a Thunderbolt to Peripheral Component Interconnect Express (PCIe) expansion chassis;
the FPGA control board is connected to the computer through the Thunderbolt to PCIe expansion chassis; the ADC and the DAC are installed on the FPGA control board; the ADC is connected to the photodetector; the DAC is separately connected to the galvanometer motor and the high-voltage amplifier; and the computer is connected to the high-precision wavelength meter; and
the computer is configured to sequentially control the piezoelectric control board, the galvanometer motor, and the piezoelectric ceramic according to the current wavelength value and the target wavelength value.

10. The FPGA-based control method for a Ti:sapphire laser according to claim 7, wherein the piezoelectric ceramic comprises first piezoelectric ceramic and second piezoelectric ceramic; the first piezoelectric ceramic, the second piezoelectric ceramic, and the first plane mirror are bonded in sequence; the first piezoelectric ceramic has a displacement greater than 20 μm; and the second piezoelectric ceramic has a displacement less than 10 μm.

11. The FPGA-based control method for a Ti:sapphire laser according to claim 7, wherein the high-precision wavelength meter is a WS7-series wavelength meter.

12. The FPGA-based control method for a Ti:sapphire laser according to claim 7, wherein the photodetector performs signal detection by means of extracavity detection.

13. The FPGA-based control method for a Ti:sapphire laser according to claim 7, wherein the high-voltage amplifier is a broadband high-voltage amplifier having a high slew rate greater than 3 V/μs.
